(19) United States
(12) Patent Application Publication
(10) Pub. No.: US 2026/0091572 A1
(43) Pub. Date: Apr. 2, 2026

(54) REINFORCEMENT FILM FOR A SANDWICH CORE AND METHOD OF MAKING A REINFORCED SANDWICH CORE

(71) Applicant: The Boeing Company, Arlington, VA (US)

(72) Inventor: Jeffrey E. POLUS, Hillsboro, IL (US)

(73) Assignee: The Boeing Company, Arlington, VA (US)

(21) Appl. No.: 18/900,005

(22) Filed: Sep. 27, 2024

(51) Int. Cl. B32B 17/02; B32B 7/06; B32B 37/10; B32B 37/12

(52) U.S. Cl. CPC B32B 17/02; B32B 7/06; B32B 37/1009; B32B 37/1284; B32B 2305/02; B32B 2305/08; B32B 2305/22; B32B 2305/74; B32B 2307/306; B32B 2307/546; B32B 2307/7242; B32B 2307/7376

(57) ABSTRACT

A reinforcement film for a sandwich core, can include a removable layer; a removable adhesive layer; a reinforcement mesh; and an adhesive layer, wherein the removable adhesive layer is disposed on the removable layer and removably joins the removable layer to the reinforcement mesh, and wherein the adhesive layer is disposed on the reinforcement mesh and the adhesive layer is configured to permanently bond the reinforcement mesh to a sandwich core.

### TECHNICAL FIELD

The present disclosure generally relates to methods of making sandwich cores and structures. More particularly, the present disclosure relates to a reinforcement film for a reinforced sandwich core and methods of making a reinforced sandwich core and reinforced sandwich structure using the reinforcement film.

### BACKGROUND

Structures used for aerospace applications can include sandwich cores and structures. Sandwich structures or panels generally include a low-density sandwich core between two face sheets of material having a high tensile and compression strength. For example, low-density sandwich cores can include paper, metal, or composite honeycomb cores and solid or machined foam cores, and the face sheets or skins can include layers of metal, composite, fiberglass, or ceramic materials. The low-density sandwich cores can form a plurality of cells, such as an array of honeycomb cells typical of honeycomb cores.

The sandwich structures can be used for structures with difficult geometries, such as leading edges of an aircraft. Thus, in some situations, the sandwich cores need to be shaped into highly complex or contoured shapes as part of the process of making a sandwich structure.

Accordingly, there is a need for reinforcement films and methods of making a reinforced sandwich core and reinforced sandwich structure using the reinforcement films to create sandwich cores and structures with highly complex or contoured shapes.

### BRIEF SUMMARY

This summary is intended merely to introduce a simplified summary of some aspects of one or more implementations of the present disclosure. This summary is not an extensive overview, nor is it intended to identify key or critical elements of the present teachings, nor to delineate the scope of the disclosure. Rather, its purpose is merely to present one or more concepts in simplified form as a prelude to the detailed description below.

The foregoing and/or other aspects and utilities exemplified in the present disclosure may be achieved by providing a reinforcement film for a sandwich core, including a removable layer; a removable adhesive layer; a reinforcement mesh; and an adhesive layer, wherein the removable adhesive layer is disposed on the removable layer and removably joins the removable layer to the reinforcement mesh, and wherein the adhesive layer is disposed on the reinforcement mesh and the adhesive layer is configured to permanently bond the reinforcement mesh to a sandwich core.

The reinforcement film can withstand a temperature of up to and including 350° F.

The reinforcement film can be sufficiently flexible to conform to a surface of the sandwich core.

The reinforcement mesh can include a fiberglass material.

The reinforcement mesh can have a thickness from about 1.0 to about 10.0 mil

The reinforcement mesh can define a plurality of openings with an average diameter from about 0.10 to about 0.50 inch

The removable layer can include a non-permeable material that can hold a vacuum.

The removable layer can include a fiberglass fabric.

The adhesive layer can be disposed only on an exterior surface of the reinforcement mesh, such that the adhesive layer does not affect an open mesh nature of the reinforcement mesh.

The adhesive layer may not substantially block or impede the plurality of openings.

The foregoing and/or other aspects and utilities exemplified in the present disclosure may be also achieved by providing a method of making a reinforced sandwich core, including providing a sandwich core; shaping a first side of the sandwich core; applying a first reinforcement film to the shaped first side; shaping a second side of the sandwich core; applying a second reinforcement film to the shaped second side; removing a first removable layer from the first reinforcement film and removing a second removable layer from the second reinforcement film; and cleaning the sandwich core, wherein the first reinforcement film includes a first removable layer, a removable adhesive layer, a first reinforcement mesh, and an adhesive layer, wherein said removable adhesive layer is disposed on the first removable layer and removably joins the first removable layer to the first reinforcement mesh, and wherein said adhesive layer is disposed on the first reinforcement mesh, and said adhesive layer can be configured to permanently bond the first reinforcement mesh to the first side, and wherein the second reinforcement film includes a second removable layer, a removable adhesive layer, a second reinforcement mesh, and an adhesive layer, wherein said removable adhesive layer is disposed on the second removable layer and removably joins the second removable layer to the second reinforcement mesh, and wherein said adhesive layer is disposed on the second reinforcement mesh, and said adhesive layer is configured to permanently bond the second reinforcement mesh to the second side.

The sandwich core can include a plurality of hollow cells defining a plurality of air passages between the first side and the second side of the sandwich core.

The first reinforcement mesh can include a plurality of openings, wherein applying the first reinforcement film to the shaped first side includes aligning the plurality of openings of the first reinforcement mesh with the plurality of hollow cells in the first side of the sandwich core, and wherein applying the second reinforcement film to the shaped second side includes aligning the plurality of openings of the second reinforcement mesh with the plurality of hollow cells in the second side of the sandwich core.

Applying the first reinforcement film to the shaped first side can include at least partially curing the first reinforcement mesh bonded to the shaped first side.

Shaping the second side can include securing the sandwich core by applying a vacuum to the first reinforcement film.

Removing the first removable layer from the first reinforcement film and removing the second removable layer from the second reinforcement film may not damage or displace the sandwich core.

Cleaning the sandwich core can include applying a vacuum and/or blowing air through the first reinforcement mesh and the first side and the second reinforcement mesh and the second side to remove debris from the sandwich core.

The foregoing and/or other aspects and utilities exemplified in the present disclosure may be also achieved by providing a method of making a reinforced sandwich structure, including providing a reinforced sandwich core according to a method of making a reinforced sandwich core as described above; and applying a first skin to a first side of the reinforced sandwich core and applying a second skin to a second side of the reinforced sandwich core.

The method can further include curing the first skin and the second skin by applying one of a curing pressure or temperature to the first skin and the second skin disposed on the reinforced sandwich core.

The foregoing and/or other aspects and utilities exemplified in the present disclosure may be also achieved by providing a reinforced sandwich structure, including a sandwich core defining a plurality of hollow cells; a first reinforcement mesh defining a plurality of openings disposed on a first side of the sandwich core; a first skin disposed over the first reinforcement mesh; a second reinforcement mesh defining a plurality of openings disposed on a second side of the sandwich core; and a second skin disposed over the second reinforcement mesh, wherein the first and second reinforcement mesh includes a fiber-reinforced plastic, wherein the plurality of openings in the first reinforcement mesh and the second reinforcement mesh align with the hollow cells, and wherein the plurality of openings in the first reinforcement mesh and the second reinforcement mesh have an average diameter corresponding to at least 20% of an average diameter of the plurality of hollow cells.

Further areas of applicability will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The accompanying drawings, which are incorporated in, and constitute a part of this specification, illustrate implementations of the present teachings and, together with the description, serve to explain the principles of the disclosure. In the figures:

FIG. 1 illustrates a reinforcement film according to an implementation of the present disclosure.

FIG. 2 illustrates a reinforcement mesh according to an implementation of the present disclosure.

FIG. 3 illustrates a method of making a reinforced sandwich core according to an implementation of the present disclosure.

FIG. 4 illustrates a reinforced sandwich core created according to an implementation of the method illustrated in FIG. 3.

FIG. 5 illustrates a reinforced sandwich core created according to an implementation of the method illustrated in FIG. 3.

FIG. 6 illustrates a reinforced sandwich core created according to an implementation of the method illustrated in FIG. 3.

FIG. 7 illustrates a reinforced sandwich core created according to an implementation of the method illustrated in FIG. 3.

FIG. 8 illustrates a method of making a reinforced sandwich structure according to an implementation of the present disclosure.

FIG. 9 illustrates a reinforced sandwich structure created according to an implementation of the method illustrated in FIG. 8.

FIG. 10 illustrates a flow diagram of aircraft production and service methodology.

FIG. 11 illustrates a block diagram of an aircraft.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary implementations of the present teachings, examples of which are illustrated in the accompanying drawings. Generally, the same reference numbers will be used throughout the drawings to refer to the same or like parts.

Throughout the specification and claims, the following terms take the meanings explicitly associated herein, unless the context clearly dictates otherwise. Phrases, such as, “in an implementation,” “in certain implementations,” and “in some implementations” as used herein do not necessarily refer to the same implementation(s), though they may. Furthermore, the phrases “in another implementation” and “in some other implementations” as used herein do not necessarily refer to a different implementation, although they may. As described below, various implementations can be readily combined, without departing from the scope or spirit of the present disclosure.

As used herein, the term “or” is an inclusive operator, and is equivalent to the term “and/or,” unless the context clearly dictates otherwise. The term “based on” is not exclusive and allows for being based on additional factors not described unless the context clearly dictates otherwise. In the specification, the recitation of “at least one of A, B, and C,” includes implementations containing A, B, or C, multiple examples of A, B, or C, or combinations of A/B, A/C, B/C, A/B/B/, B/B/C, A/B/C, etc. In addition, throughout the specification, the meaning of “a,” “an,” and “the” include plural references. The meaning of “in” includes “in” and “on. ” Similarly, implementations of the present disclosure may suitably comprise, consist of, or consist essentially of, the elements A, B, C, etc.

It will also be understood that, although the terms first, second, etc. can be used herein to describe various elements, these elements should not be limited by these terms. These terms are only used to distinguish one element from another. For example, a first object, component, or step could be termed a second object, component, or step, and, similarly, a second object, component, or step could be termed a first object, component, or step, without departing from the scope of the invention. The first object, component, or step, and the second object, component, or step, are both, objects, component, or steps, respectively, but they are not to be considered the same object, component, or step. It will be further understood that the terms “includes,” “including,” “comprises” and/or “comprising,” when used in this specification, specify the presence of stated features, steps, operations, elements, and/or components, but do not preclude the presence or addition of one or more other features, steps, operations, elements, components, and/or groups thereof. Further, as used herein, the term “if” can be construed to mean “when” or “upon” or “in response to determining” or “in response to detecting,” depending on the context.

All physical properties that are defined hereinafter are measured at 20° C. to 25° C. (68° F. to 77° F.) unless otherwise specified.

When referring to any numerical range of values herein, such ranges are understood to include each and every number and/or fraction between the stated range minimum and maximum, as well as the endpoints. For example, a range of 0.5% to 6% would expressly include all intermediate values of, for example, 0.6%, 0.7%, and 0.9%, all the way up to and including 5.95%, 5.97%, and 5.99%, among many others. The same applies to each other numerical property and/or elemental range set forth herein, unless the context clearly dictates otherwise.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges. The terms “about” or “substantial” and “substantially” or “approximately,” with reference to amounts or measurement values, are meant that the recited characteristic, parameter, or values need not be achieved exactly. Rather, deviations or variations, including, for example, tolerances, measurement error, measurement accuracy limitations, and other factors known to those skilled in the art, may occur in amounts that do not preclude the effect that the characteristic was intended to provide. As used herein, “about” is to mean within +/−10 % of a stated target value, maximum, or minimum value.

Unless otherwise specified, all percentages and amounts expressed herein and elsewhere in the specification should be understood to refer to percentages by weight. The percentages and amounts given are based on the active weight of the material. For example, for an active ingredient provided as a solution, the amounts given are based on the amount of the active ingredient without the amount of solvent or may be determined by weight loss after evaporation of the solvent.

With regard to procedures, methods, techniques, and workflows that are in accordance with some implementations, some operations in the procedures, methods, techniques, and workflows disclosed herein can be combined and/or the order of some operations can be changed.

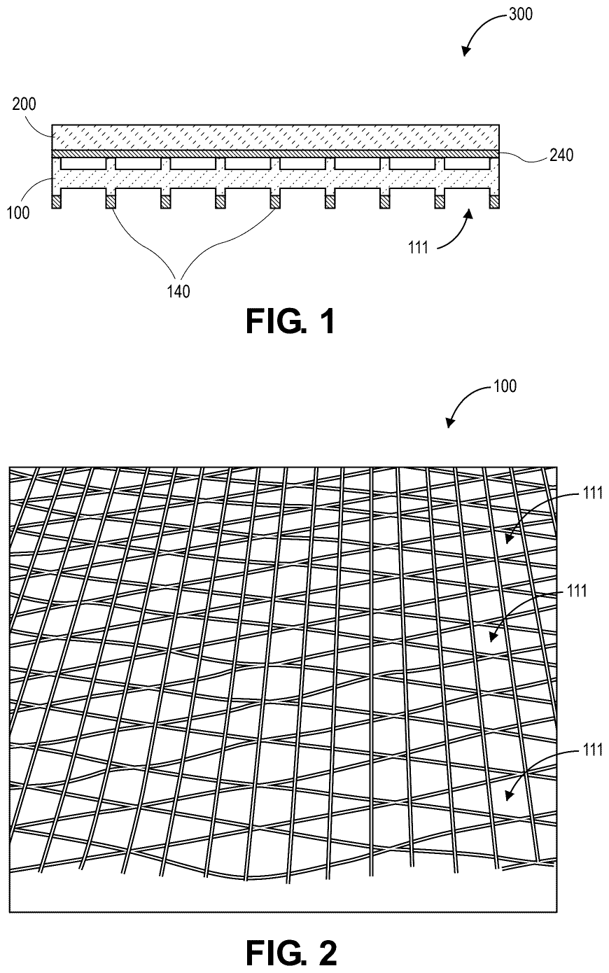

FIG. 1 illustrates a reinforcement film according to an implementation of the present disclosure. As illustrated in FIG. 1, a reinforcement film 300 for a sandwich core 400 can include a removable layer 200, a removable adhesive layer 240, a reinforcement mesh 100, and an adhesive layer 140. The removable adhesive layer 240 is disposed on the removable layer 200 and removably joins the removable layer 200 to the reinforcement mesh 100. The adhesive layer 140 is disposed on the reinforcement mesh 100 and the adhesive layer 140 is configured to bond the reinforcement mesh 100 to a sandwich core 400. The adhesive layer 140 can permanently bond the reinforcement mesh 100 to the sandwich core 400.

The reinforcement film 300 can have a total thickness from about 5.0 to about 25.0 mil. For example, the reinforcement film 300 can have a thickness from about 10 to about 20 mil or from about 15 to about 20 mil. In one implementation, the reinforcement film 300 has a thickness from about 14 to about 18 mil.

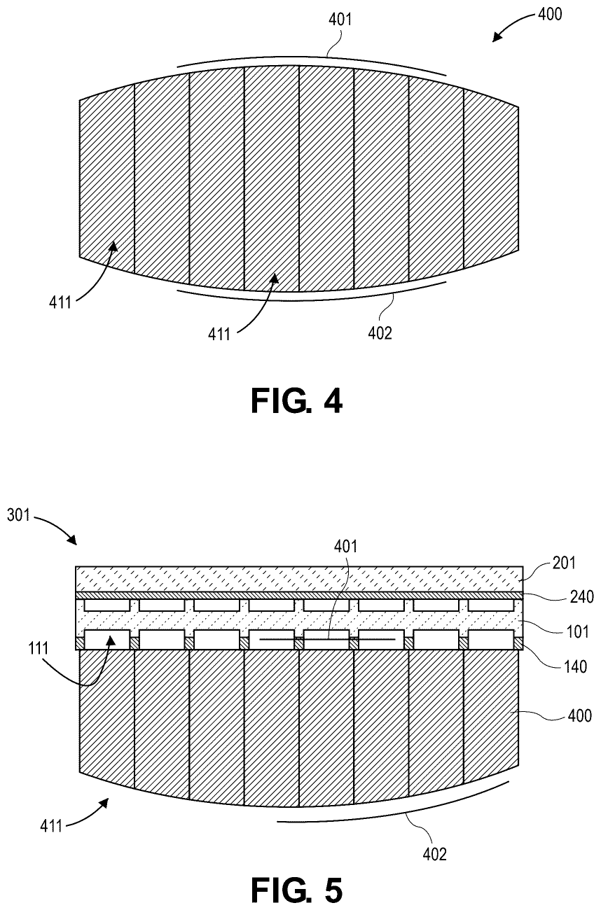

The reinforcement film 300 can be configured to withstand the processing temperatures involved in the shaping and forming of the sandwich core 400 (see FIGS. 4-5). For example, the reinforcement film 300 can withstand temperatures of about 100° F. or greater, of about 200° F. or greater, or of about 300° F. or greater. In other implementations, the reinforcement film 300 can withstand temperatures of about 350° F. or less, of about 200° F. or less, or of about 100° F. or less. In one implementation, the reinforcement film 300 can withstand a temperature of up to and including 350° F.

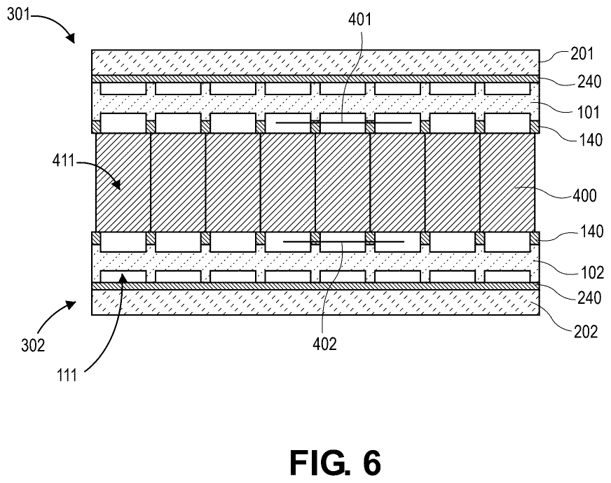

The reinforcement film 300 is flexible. For example, the reinforcement film 300 can be sufficiently flexible to conform to a surface of the sandwich core 400 (see FIGS. 5-6). In some implementations, the sandwich core 400 is highly contoured and the reinforcement film 300 is flexible enough to conform to a highly contoured surface of the sandwich core 400.

FIG. 1 illustrates a reinforcement mesh according to an implementation of the present disclosure. As illustrated in FIG. 1, a reinforcement mesh 100 comprises an open mesh material. The reinforcement mesh 100 can include filaments that intersect each other and that can be bonded in at least some of their points of intersection to create a lightweight open mesh material. For example, the reinforcement mesh 100 can include filaments that are bonded at the intersection nodes or the reinforcement mesh 100 can include a woven or knitted product.

The reinforcement mesh 100 can be flexible. For example, the reinforcement film 300 can be sufficiently flexible to conform to a surface of the sandwich core 400 (see FIGS. 5-6). In one implementation, the reinforcement mesh 100 is flexible in an uncured state, such that it can easily conform to a contoured surface of the sandwich core 400. In some implementations, the reinforcement mesh 100 can become rigid after curing.

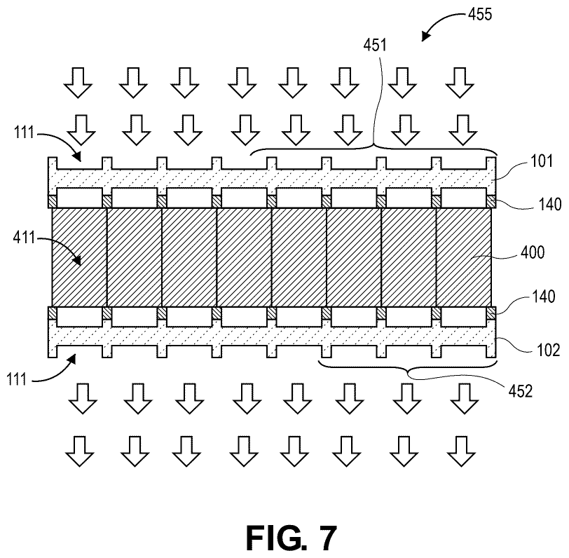

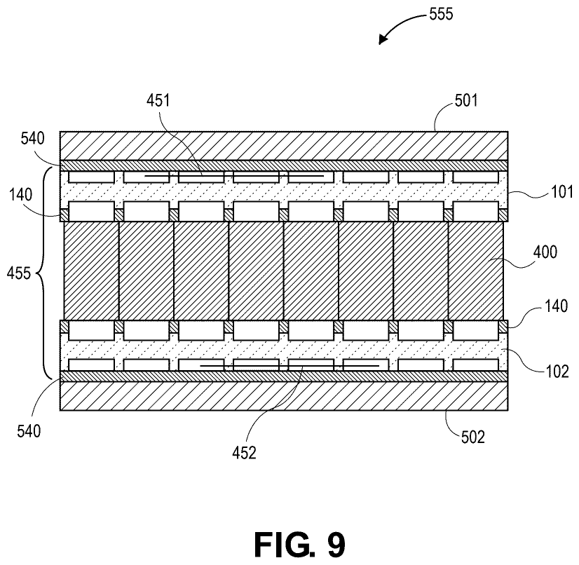

The reinforcement mesh 100 can be configured to withstand the processing temperatures involved in the creation or curing of a reinforced sandwich core 455 (see FIG. 7) or reinforced sandwich structure 555 (see FIG. 9). For example, the reinforcement mesh 100 can withstand temperatures of about 100° F. or greater, of about 200° F. or greater, or of about 300° F. or greater. In other implementations, the reinforcement mesh 100 can withstand temperatures of about 350° F. or less, of about 200° F. or less, or of about 100° F. or less. In one implementation, the reinforcement mesh 100 can withstand a temperature of up to and including 350° F.

The reinforcement mesh 100 can include a fiber-reinforced plastic, such as fiberglass, a carbon-fiber-reinforced polymer, an aramid, and the like. For example, the reinforcement mesh 100 can comprise a fiberglass material, such as an S-2 glass fiber material. In other implementations, the reinforcement mesh 100 can include a polyester or Nylon material.

In some implementations, the reinforcement mesh 100 can be conductive and the reinforcement mesh 100 can include conductive materials, such as carbon fibers. In other implementations, the reinforcement mesh 100 is non-conductive and/or dielectric, and the reinforcement mesh 100 does not include conductive materials, such as carbon fibers. For example, the reinforcement mesh 100 can be non-conductive and the reinforcement mesh 100 can include only materials with low dielectric values.

The reinforcement mesh 100 can have a thickness from about 1.0 to about 10.0 mil. For example, the reinforcement mesh 100 can have a thickness from about 2.0 to about 9.0 mil or from about 3.0 to about 8.0 mil. In one implementation, the reinforcement mesh 100 has a thickness from about 4.0 to about 6 mil.

In other implementations, the reinforcement mesh 100 can have a thickness of about 10.0 mil or less, of about 9.0 mil or less, of about 8.0 mil or less, of about 7.0 mil or less, of about 6.0 mil or less, of about 5.0 mil or less, of about 4.0 mil or less, of about 3.0 mil or less, or of about 2.0 mil or less.

In some implementations, a thickness under 10 mil allows the reinforcement mesh 100 to be completely wetted out (or engulfed) when it is bonded to the outer skins (501 and/or 502) to form the reinforced sandwich structure 555.

As illustrated in FIGS. 1-2, the reinforcement mesh 100 defines an open mesh.

The reinforcement mesh 100 can define a plurality of openings 111 with an average diameter from about 0.10 to about 0.50 inch. For example, the reinforcement mesh 100 can include a plurality of openings 111 with an average diameter from about 0.10 to about 0.40 inch, from about 0.10 to about 0.35 inch, from about 0.10 to about 0.30 inch, or from about 0.10 to about 0.25 inch. In other implementations, the reinforcement mesh 100 include a plurality of openings 111 with an average diameter of at least 0.10 inch, of at least 0.15 inch, of at least 0.20 inch, of at least 0.25 inch, of at least 0.30 inch, of at least 0.35 inch, of at least 0.40 inch. As described below, in some implementations, the open mesh of the reinforcement mesh 100 is configured to correspond to an array of hollow cells 411 in a sandwich core 400 (see FIGS. 5-6). In some implementations, the open mesh defined by the reinforcement mesh 100 needs to be sufficiently tight to provide adequate reinforcement to the sandwich core 400, but not small enough to prevent cleaning of and/or debris removal from the sandwich core 400.

The removable layer 200 can be flexible. For example, the removable layer 200 can be sufficiently flexible to conform to a contoured surface of the sandwich core 400 (see FIGS. 5-6).

The removable layer 200 can hold a vacuum. For example, the removable layer 200 can comprise a non-permeable material that can hold a vacuum.

The removable layer 200 can be configured to withstand the processing temperatures involved in the shaping and forming of the sandwich core 400 (see FIGS. 4-5). For example, the removable layer 200 can withstand temperatures of about 100° F. or greater, of about 200° F. or greater, or of about 300° F. or greater. In other implementations, the removable layer 200 can withstand temperatures of about 350° F. or less, of about 200° F. or less, or of about 100° F. or less. In one implementation, the removable layer 200 can withstand a temperature of up to and including 350° F. For example, from about 250° F. up to and including 350° F.

The removable layer 200 can comprise a fiberglass prepreg cloth. The removable layer 200 can comprise a fiberglass fabric, such as an 120 E-Glass fiberglass cloth. In other implementations, the removable layer 200 can comprise a plastic polymer material, such as a thermoset or thermoplastic material. The removable layer can comprise at least one of nylon, thermoplastic elastomers (TPE), silicon, natural rubber, natural or synthetic latex, polyethylene (PE), or combinations thereof.

The removable layer 200 can have a thickness from about 5.0 to about 25 mil. For example, the removable layer 200 can have a thickness from about 5.0 to about 20 mil, from about 5.0 to about 15 mil, from about 10 to about 15 mil, or from about 10 to about 12 mil. In other implementations, the removable layer 200 can have a thickness of about 20 mil or less, of about 15 mil or less, or of about 12 mil or less. In some implementations, the removable layer 200 must be sufficiently thick for use with a vacuum chuck and/or hold a vacuum.

As illustrated in FIG. 1, The removable adhesive layer 240 is disposed on the removable layer 200, and the removable adhesive layer 240 removably joins the removable layer 200 to the reinforcement mesh 100.

The removable adhesive layer 240 can be bonded to the removable layer 200. For example, the removable adhesive layer 240 can be permanently bonded to the removable layer 200, such that the removable adhesive layer 240 remains with the removable layer 200 when the removable layer 200 is removed (see FIG. 7). The removable adhesive layer 240 can be removably joined to the reinforcement mesh 100. For example, the removable layer 200 can removably join the reinforcement mesh 100 to the removable layer 200, such that the removable layer 200 and the removable adhesive layer 240 can be easily removed from the reinforcement mesh 100 (see FIG. 7). Accordingly, the removable adhesive layer 240 can be configured to allow for the easy removal of the removable layer 200 from the reinforcement mesh 100 without damaging or displacing the reinforcement mesh 100 after the reinforcement mesh 100 is applied to a sandwich core 400.

The removable adhesive layer 240 can comprise a low adhesive material, such as a low adhesive epoxy. In some implementations, the removable adhesive layer 240 comprises a release layer in contact with the reinforcement mesh 100 and a low adhesive material in contact with the removable layer 200 to allow removal of the removable layer 200 from the reinforcement mesh 100 without damaging or displacing the reinforcement mesh.

The removable adhesive layer 240 can have a thickness from about 5.0 to about 15 mil. For example, the removable adhesive layer 240 can have a thickness from about 10.0 to about 15 mil or from about 10.0 to about 12 mil.

The adhesive layer 140 is disposed on the reinforcement mesh 100. The adhesive layer 140 is configured to bond the reinforcement mesh 100 to a sandwich core 400 (see FIGS. 5-6).

As illustrated in FIG. 1, the adhesive layer 140 can be disposed only on an exterior surface of the reinforcement mesh 100, which will bond to the sandwich core 400. In some implementations, the adhesive layer 140 does not affect an open mesh nature of the reinforcement mesh 100. For example, the adhesive layer 140 can be disposed on the reinforcement mesh 100, such that the adhesive layer 140 does not substantially block or impede the plurality of openings 111. In some implementations, the adhesive layer 140 allows wind or vacuum to pass through the plurality of openings 111.

The adhesive layer 140 can comprise materials configured to bond to the materials of the sandwich core 400. For example, the adhesive layer 140 can be configured to bond the reinforcement mesh 100 to paper, metal, or composite honeycomb cores, and/or solid or machined foam cores. In some implementations, the adhesive layer 140 comprises adhesive materials in the same family as the adhesives used in the sandwich core 400 or reinforced sandwich structure 555. Accordingly, the adhesive layer 140 can be compatible with adhesives used with the sandwich core 400 or the reinforced sandwich structure 555 in terms of curing or processing conditions, such as temperatures, and chemical reactivity or incompatibility.

The adhesive layer 140 can comprise thermosetting materials, film adhesives, and/or structural film adhesives, such as a pre-cured thermoset material or a thermoplastic material, and/or a pressure-sensitive or heat-activated adhesive. The adhesive layer 140 can comprise an epoxy. For example, the adhesive layer 140 can comprise an epoxy film adhesive, such as AF555 from the 3M Company or MB1515 from Cytec Engineered Materials, particularly suited for use with composite materials. In other implementations, the adhesive layer 140 can comprise a standard structural film adhesive such as FM300 or FM309 from SYENSQO. In other implementations, the adhesive layer 140 can be cyanate ester based or Bismaleimide based.

The adhesive layer 140 can have a thickness from about 5.0 to 15 mil. For example, the adhesive layer 140 can have a thickness from about 5.0 to about 10 mil or from about 5.0 to about 12 mil. In one implementation, the adhesive layer 140 has a thickness from about 6.0 to 10 mil.

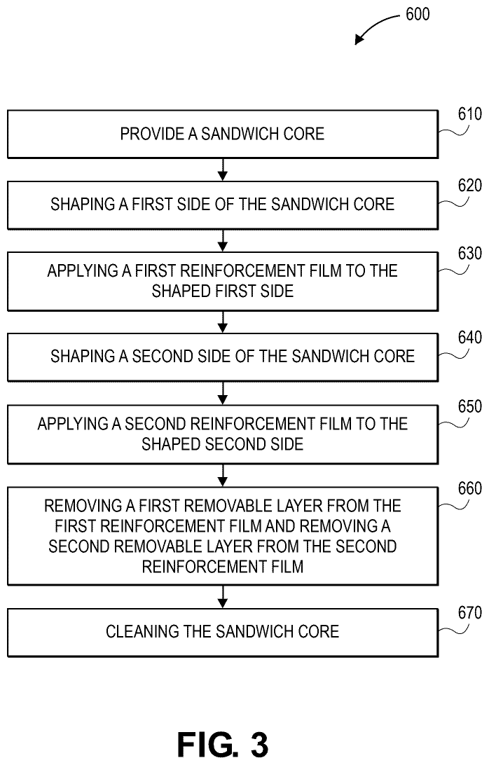

FIG. 3 illustrates a method of making a reinforced sandwich core according to an implementation of the present disclosure. FIGS. 4-7 illustrate a reinforced sandwich core created according to an implementation of the method illustrated in FIG. 3. FIGS. 3-7 illustrates an example of a method that, for instance, utilizes the reinforcement film 300 described above and as illustrated in FIGS. 1-2. As such, the discussion below will reference various components as illustrated in FIG. 1-2.

As illustrated in FIG. 3, a method 600 of making a reinforced sandwich core 455, includes providing a sandwich core 400 in operation 610, shaping a first side 401 of the sandwich core 400 in operation 620, applying a first reinforcement film 301 to the shaped first side 401 in operation 630, shaping a second side 402 of the sandwich core 400 in operation 640, applying a second reinforcement film 302 to the shaped second side 402 in operation 650, removing a first removable layer 201 from the first reinforcement film 301 and removing a second removable layer 202 from the second reinforcement film 302 in operation 660, and cleaning the sandwich core 400 in operation 670 to create a reinforced sandwich core 455.

The first reinforcement film 301 and the second reinforcement film 302 each correspond to the reinforcement film 300 illustrated in FIGS. 1-2. Accordingly, as illustrated in FIG. 6, each of the first and second reinforcement films 301 and 302 comprise a removable layer 200 (first and second removable layer 201 and 202, respectively), a removable adhesive layer 240, a reinforcement mesh 100 (first and second reinforcement mesh 101 and 102, respectively), and an adhesive layer 140. For example, the first reinforcement film 301 can include a first removable layer 201, a removable adhesive layer 240, a first reinforcement mesh 101, and an adhesive layer 140. Said removable adhesive layer 240 can be disposed on the first removable layer 201 and removably joins the first removable layer 201 to the first reinforcement mesh 101. Said adhesive layer 140 can be disposed on the first reinforcement mesh 101, and said adhesive layer 140 can be configured to permanently bond the first reinforcement mesh 101 to the first side 401. Similarly, the second reinforcement film 302 can include a second removable layer 202, a removable adhesive layer 240, a second reinforcement mesh 102, and an adhesive layer 140. Said removable adhesive layer 240 can be disposed on the second removable layer 202 and removably joins the second removable layer 202 to the second reinforcement mesh 102. Said adhesive layer 140 can be disposed on the second reinforcement mesh 102, and said adhesive layer 140 can be configured to permanently bond the second reinforcement mesh 102 to the second side 402.

As described above, method 600 can begin with providing a sandwich core 400 in operation 610.

The sandwich core 400 can comprise a plurality of strips of material which are bonded together and expanded to create a honeycomb core. For example, adhesives can be applied to material in strips or sheets, which are then successively assembled and stacked, such that, when expanded the bonded material forms a honeycomb core. In other implementations, the material is fusion bonded together. In yet other examples, a block of material can molded, machined, or extruded into a cellular geometry, such as a honeycomb. The material used to create the honeycomb core can be coated. For example, the honeycomb core can be resin-coated with a polymer material, such as an epoxy resin.

As illustrated in FIG. 4, the sandwich core 400 can comprise a plurality of hollow cells 411 defining a honeycomb or cellular geometry. The sandwich core 400 can comprise a first side 401 defining a top open face of the sandwich core 400 and a second side 402 defining a bottom open face of the sandwich core 400. Accordingly, the plurality of hollow cells 411 define a plurality of air passages between the first side 401 and the second side 402. The plurality of hollow cells 411 can have an average diameter from about 0.10 inch to about 0.50 inch. For example, the plurality of hollow cells 411 can have an average diameter from about 0.10 inch to about 0.40 inch, from about 0.10 inch to about 0.30, or from about 0.10 inch to about 0.25. In one implementation, the plurality of hollow cells 411 have an average diameter of about 0.125 inch.

The sandwich core 400 can comprise paper, metal, or a composite material formed into a honeycomb form. The sandwich core 400 can comprise a composite foam material molded or machined into a honeycomb form. For example, the sandwich core 400 can comprise a solid or machined foam core. In one implementation, the sandwich core 400 comprises an expanded composite honeycomb core. In another implementation, the sandwich core 400 comprises a resin-coated expanded honeycomb core. For example, the sandwich core 400 can be dipped in phenolic resin.

Operation 620 includes shaping a first side 401 of the sandwich core 400. The sandwich core 400 can be shaped using any conventional style of cutter or machining capable of defining a contour to the sandwich core 400. For example, the sandwich core 400 can be shaped using a disc-shaped cutter or an integral shank honeycomb cutter.

The sandwich core 400 can be shaped into a curved shaped, such as a wedge shape. In other implementations, the sandwich core 400 can be shaped into a highly contoured shape. As used herein, the term highly contoured refers to a surface which contours in two simultaneous directions. Accordingly, shaping the first side 401 of the sandwich core 400 can include shaping a highly contoured surface to the first side 401.

Operation 630 includes applying a first reinforcement film 301 to the shaped first side 401. As illustrated in FIG. 5, after the first side 401 is shaped in operation 620, a first reinforcement film 301 can be applied to the shaped first side 401 in operation 630.

As described above, the first reinforcement film 301 can include a first removable layer 201, a removable adhesive layer 240, a first reinforcement mesh 101, and an adhesive layer 140. The removable adhesive layer 240 is disposed on the first removable layer 201 and removably joins the first removable layer 201 to the first reinforcement mesh 101. The adhesive layer 140 is disposed on the first reinforcement mesh 101 and the adhesive layer 140 is configured to bond the first reinforcement mesh 101 to a first side 401 of the sandwich core 400.

Accordingly, applying the first reinforcement film 301 to the shaped first side 401 can include bonding the first reinforcement mesh 101 to the shaped first side 401. In one implementation, the adhesive layer 140 disposed on the first reinforcement mesh 101 creates a permanent bond between the first reinforcement mesh 101 and the shaped first side 401.

As illustrated in FIG. 5, the first reinforcement mesh 101 includes a plurality of openings 111. Accordingly, in some implementations, applying the first reinforcement film 301 to the shaped first side 401 includes aligning the plurality of openings 111 of the first reinforcement mesh 101 with the plurality of hollow cells 411 in the first side 401 of the sandwich core 400.

The reinforcement mesh 100 is flexible enough to conform to a contoured surface. In some implementations, the first side 401 comprises a highly contoured shape, and the first reinforcement mesh 101 is sufficiently flexible to bond to the highly contoured first side 401. In other implementations, the first reinforcement mesh 101 can become more rigid after curing. Accordingly, applying a first reinforcement film 301 to the shaped first side 401 can include at least partially curing the first reinforcement mesh 101 bonded to the shaped first side 401. Curing can comprise applying at least one of heat and pressure to the first reinforcement mesh 101. In other implementations, applying a first reinforcement film 301 to the shaped first side 401 can include fully curing the first reinforcement mesh 101 bonded to the shaped first side 401 to provide more structural rigidity to the shaped first side 401.

In one implementation, the at least partially cured first reinforcement mesh 101 adds rigidity and/or robustness to the sandwich core 400. For example, by placing the first reinforcement film 301 on the first side 401 of the sandwich core 400, the sandwich core 400 is less likely to distort while it is moved around during shaping operations. As described below, a vacuum can be applied to the first reinforcement film 301 to secure the sandwich core 400 during shaping operations. In other implementations, the at least partially cured first reinforcement mesh 101 helps protect a highly contoured first side 401 during subsequent manufacturing operations, such as during the creation of a reinforced sandwich structure 555 (FIG. 9).

Operation 640 includes shaping a second side 402 of the sandwich core 400. Shaping of the second side 402 can use similar methods as shaping of the first side 401. Shaping the second side 402 of the sandwich core 400 can include shaping a highly contoured surface to the second side 402.

In some implementations, shaping the second side 402 requires securing the sandwich core 400. For example, the sandwich core 400 can be secured using vacuum to hold the sandwich core 400 in place while the second side 402 is shaped. As described above, the removable layer 200 can hold a vacuum. Accordingly, as illustrated in FIG. 5, the first reinforcement film 301 can be used to secure the sandwich core 400. For example, a vacuum shuck can be used to apply a vacuum to the first removable layer 201 of the first reinforcement film 301 applied to the first side 401 to secure the sandwich core 400 to shape the second side 402. The vacuum shuck can be contoured to accommodate a highly contoured first side 401.

Shaping the second side 402 of the sandwich core 400 can thus include applying a vacuum to the first reinforcement film 301 to secure the sandwich core 400.

Operation 650 includes applying a second reinforcement film 302 to the shaped second side 402. As illustrated in FIG. 6, after the second side 402 is shaped in operation 640, a second reinforcement film 302 can be applied to the shaped second side 402 in operation 650.

As described above, the second reinforcement film 302 can include a second removable layer 202, a removable adhesive layer 240, a second reinforcement mesh 102, and an adhesive layer 140. The removable adhesive layer 240 is disposed on the second removable layer 202 and removably joins the second removable layer 202 to the second reinforcement mesh 102. The adhesive layer 140 is disposed on the second reinforcement mesh 102 and the adhesive layer 140 is configured to bond the second reinforcement mesh 102 to a second side 402 of the sandwich core 400.

Accordingly, applying the second reinforcement film 302 to the shaped second side 402 can include bonding the second reinforcement mesh 102 to the shaped second side 402. In one implementation, the adhesive layer 140 disposed on the second reinforcement mesh 102 creates a permanent bond between the second reinforcement mesh 102 and the shaped second side 402. In some implementations, the adhesive layer 140 is cured to permanently bond the first and second reinforcement mesh 101 and 102 to the shaped first and second side 401 and 402, respectively.

As illustrated in FIG. 6, the second reinforcement mesh 102 includes a plurality of openings 111. Accordingly, in some implementations, applying the second reinforcement film 302 to the shaped second side 402 includes aligning the plurality of openings 111 of the second reinforcement mesh 102 with the plurality of hollow cells 411 in the second side 402 of the sandwich core 400.

In some implementations, the second side 402 comprises a highly contoured shape, and the second reinforcement mesh 102 is sufficiently flexible to bond to the highly contoured second side 402. In other implementations, the second reinforcement mesh 102 can become more rigid after curing. Accordingly, applying the second reinforcement film 302 to the shaped second side 402 can include at least partially curing the second reinforcement mesh 102 bonded to the shaped second side 402. Curing can comprise applying at least one of heat and pressure to the second reinforcement mesh 102. Applying the second reinforcement film 302 to the shaped second side 402 can include fully curing the second reinforcement mesh 102 bonded to the shaped second side 402 to provide more structural rigidity to the shaped second side 402. The at least partially cured second reinforcement mesh 102 can help protect the highly contoured second side 402 during subsequent manufacturing operations, such as during the creation of a reinforced sandwich structure 555 (FIG. 9).

Operation 660 includes removing a first removable layer 201 from the first reinforcement film 301 and removing a second removable layer 202 from the second reinforcement film 302.

As described above, the removable adhesive layer 240 is configured to allow for the easy removal of the removable layer 200 from the reinforcement mesh 100 without damaging or displacing the reinforcement mesh 100 after the reinforcement mesh 100 is applied to a sandwich core 400. Accordingly, as illustrated in FIG. 7, when the first removable layer 201 is removed, the removable adhesive layer 240 disposed on the first removable layer 201 is also removed leaving behind the first reinforcement mesh 101 bonded to the first side 401 of the sandwich core 400. Similarly, when the second removable layer 202 is removed, the removable adhesive layer 240 disposed on the second removable layer 202 is also removed leaving behind the second reinforcement mesh 102 bonded to the second side 402 of the sandwich core 400.

In one implementation, removing the first removable layer 201 from the first reinforcement film 301 and removing the second removable layer 202 from the second reinforcement film 302 does not damage or displace the sandwich core 400.

Operation 670 includes cleaning the sandwich core 400. As illustrated in FIG. 7, by removing the first removable layer 201, the plurality of openings 111 of the first reinforcement mesh 101 and the plurality of hollow cells 411 in the first side 401 of the sandwich core 400 are exposed. Similarly, by removing the second removable layer 202, the plurality of openings 111 of the second reinforcement mesh 102 and the plurality of hollow cells 411 in the second side 402 of the sandwich core 400 are exposed. Accordingly, the plurality of hollow cells 411 are accessible for cleaning. For example, during a shaping process, debris may be disposed within the sandwich core 400. Accordingly, cleaning the sandwich core 400 can include applying a vacuum and/or blowing air through the first reinforcement mesh 101 and the first side 401 to remove debris from the sandwich core 400. Similarly, cleaning the sandwich core 400 can include applying a vacuum and/or blowing air through the second reinforcement mesh 102 and the second side 402 to remove debris from the sandwich core 400. The plurality of openings 111 in the first and second reinforcement mesh 101 and 102 are sized to allow debris to blow through while being sufficiently small to provided adequate reinforcement to the sandwich core 400.

In some implementations, cleaning the sandwich core 400 can further include at least partially curing the first and second reinforcement mesh 101 and 102 to increase their rigidity and/or to fully bond and/or fully cure the first and second reinforcement mesh 101 and 102 to the sandwich core 400.

After cleaning the sandwich core 400 in operation 670, a reinforced sandwich core 455 remains. As illustrated in FIG. 7, a reinforced sandwich core 455 includes a sandwich core 400 defining a plurality of hollow cells 411, a first reinforcement mesh 101 defining a plurality of openings 111 disposed on a first side 401 of the sandwich core 400, and a second reinforcement mesh 102 defining a plurality of openings 111 disposed on a second side 402 of the sandwich core 400. The plurality of openings 111 in the first reinforcement mesh 101 and the second reinforcement mesh 102 can align with the hollow cells 411. The first and second reinforcement mesh 101 and 102 can include a fiber-reinforced plastic. The plurality of openings 111 in the first reinforcement mesh 101 and the second reinforcement mesh 102 can have an average diameter corresponding to at least 20%, 30%, 40%, and 50% of an average diameter of the plurality of hollow cells 411. The sandwich core 400 can include at least one of paper, composite, or metal materials. The reinforced sandwich core 455 further includes a first adhesive layer 140 bonding the first reinforcement mesh 101 to the first side 401 of the sandwich core 400 and a second adhesive layer 140 bonding the second reinforcement mesh 102 to the second side 402 of the sandwich core 400.

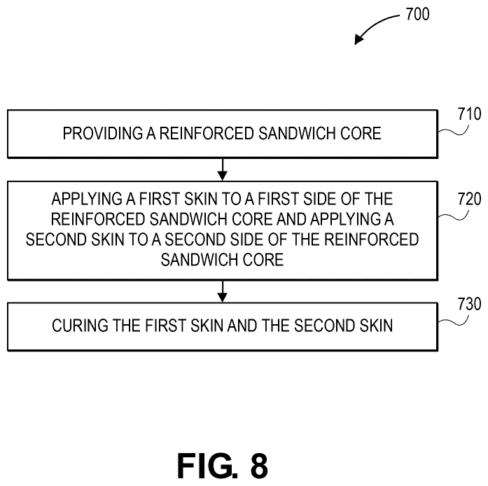

FIG. 8 illustrates a method of making a reinforced sandwich structure according to an implementation of the present disclosure. FIG. 9 illustrates a reinforced sandwich structure created according to an implementation of the method illustrated in FIG. 8. FIGS. 8-9 illustrates an example of a method that, for instance, utilizes the reinforcement film 300 described above and as illustrated in FIGS. 1-2 and the method 600 of making a reinforced sandwich core 455 as illustrated in FIGS. 3-7. As such, the discussion below will reference various components and operations as illustrated in FIG. 1-7.

As illustrated in FIG. 8, a method 700 of making a reinforced sandwich structure 555 includes providing a reinforced sandwich core 455 in operation 710, and applying a first skin 501 to a first side 451 of the reinforced sandwich core 455 and applying a second skin 502 to a second side 452 of the reinforced sandwich core 455 in operation 720. In some implementations, method 700 further includes curing the first skin 501 and the second skin 502 in operation 730.

Method 700 can start with providing a reinforced sandwich core 455 in operation 710. The reinforced sandwich core 455 can be created using method 600 of making a reinforced sandwich core 455 as described above. Accordingly, as illustrated in FIGS. 1-7, providing a reinforced sandwich core 455 can include providing a sandwich core 400, shaping a first side 401 of the sandwich core 400, applying a first reinforcement film 301 to the shaped first side 401, shaping a second side 402 of the sandwich core 400, applying a second reinforcement film 302 to the shaped second side 402, removing a first removable layer 201 from the first reinforcement film 301 and removing a second removable layer 202 from the second reinforcement film 302, and cleaning the sandwich core to create the reinforced sandwich core 455.

As illustrated in FIG. 7, a reinforced sandwich core 455 can include a sandwich core 400 defining a plurality of hollow cells 411, a first reinforcement mesh 101 defining a plurality of openings 111 disposed on a first side 401 (see FIG. 6) of the sandwich core 400 and defining a first side 451 of the reinforced sandwich core 455, and a second reinforcement mesh 102 defining a plurality of openings 111 disposed on a second side 402 (See FIG. 6) of the sandwich core 400 and defining a second side 452 of the reinforced sandwich core 455. The plurality of openings 111 in the first reinforcement mesh 101 and the second reinforcement mesh 102 can align with the hollow cells 411.

Operation 720 includes applying the first skin 501 to the first side 451 of the reinforced sandwich core 455 and applying the second skin 502 to the second side 452 of the reinforced sandwich core 455.

As illustrated in FIG. 9, applying the first skin 501 to the first side 451 of the reinforced sandwich core 455 can include disposing the first skin 501 on the first reinforcement mesh 101 disposed on the first side 401 of the sandwich core 400. Applying the second skin 502 to the second side 452 of the reinforced sandwich core 455 can include disposing the second skin 502 on the second reinforcement mesh 102 disposed on the second side 402 of the sandwich core 400.

The first skin 501 and the second skin 502 can include at least one of a metal, composite, fiberglass, and ceramic material. For example, the first skin 501 and the second skin 502 can include at least one of a composite and a metal material. In some implementations, the first skin 501 and the second skin 502 can include uncured composite skin panels or pre-pregs.

In some implementations, the first skin 501 and the second skin 502 are cured before they are applied to the reinforced sandwich core 455. Accordingly, applying the first skin 501 to the first side 451 of the reinforced sandwich core 455 and applying the second skin 502 to the second side 452 of the reinforced sandwich core 455 can include bonding the first skin 501 and the second skin 502 to the reinforced sandwich core 455.

For example, as illustrated in FIG. 9, the first skin 501 can include an adhesive layer 540. The adhesive layer 540 can be disposed on the first skin 501 and can be configured to bond the first skin 501 to the first side 451. The second skin 502 can also include an adhesive layer 540. The adhesive layer 540 can be disposed on the second skin 502 and can be configured to bond the second skin 502 to the second side 452 of the reinforced sandwich core 455. The adhesive layer 540 can comprise materials configured to bond to the materials of the first skin 501 and the second skin 502 to the reinforced sandwich core 455. For example, the adhesive layer 540 can be configured to bond paper, metal, or composite materials. The adhesive layer 540 can comprise thermosetting materials, film adhesives, and/or structural film adhesives, such as a pre-cured thermoset material or a thermoplastic material, and/or a pressure-sensitive or heat-activated adhesive

In other implementations, the one or more skin panels are pre-pregs or uncured before they are applied to the reinforced sandwich core 455 or the adhesive layer 540 may require heat and/or pressure to bond first skin 501 and the second skin 502 to the reinforced sandwich core 455. Accordingly, method 700 may further include curing the first skin 501 and the second skin 502 in operation 730.

Operation 730 includes curing the first skin 501 and the second skin 502. For example, in some implementations, the first skin 501 and the second skin 502 can include uncured composite skin panels or pre-pregs and curing the first skin 501 and the second skin 502 can include applying one of a curing pressure and/or temperature to the first skin 501 and the second skin 502 disposed on the reinforced sandwich core 455. In other implementations, curing the first skin 501 and the second skin 502 can include fusion bonding the first skin 501 and the second skin 502 to the reinforced sandwich core 455. In other implementations, curing the first skin 501 and the second skin 502 can include applying a curing temperature and/or pressure to bond the first skin 501 and the second skin 502 to the reinforced sandwich core 455.

As illustrated in FIG. 9, a reinforced sandwich structure 555 includes a sandwich core 400 defining a plurality of hollow cells 411, a first reinforcement mesh 101 defining a plurality of openings 111 disposed on a first side 401 of the sandwich core 400, a first skin 501 disposed over the first reinforcement mesh 101, a second reinforcement mesh 102 defining a plurality of openings 111 disposed on a second side 402 of the sandwich core 400, and a second skin 502 disposed over the second reinforcement mesh 102. The reinforced sandwich structure 555 can further includes a first adhesive layer 140 bonding the first reinforcement mesh 101 to the first side 401 of the sandwich core 400 and a second adhesive layer 140 bonding the second reinforcement mesh 102 to the second side 402 of the sandwich core 400. The reinforced sandwich structure 555 can further includes an adhesive layer 540 bonding the first skin 501 to the first reinforcement mesh 101 and another adhesive layer 540 bonding the second skin 502 to the second reinforcement mesh 102.

The first and second reinforcement mesh 101 and 102 can include a fiber-reinforced plastic. The plurality of openings 111 in the first reinforcement mesh 101 and the second reinforcement mesh 102 can align with the hollow cells 411. The plurality of openings 111 in the first reinforcement mesh 101 and the second reinforcement mesh 102 can have an average diameter corresponding to at least 20%, 30%, 40%, and 50% of an average diameter of the plurality of hollow cells 411. The sandwich core 400 can include at least one of paper, composite, and metal materials. The first skin 501 and the second skin 502 can include at least one of a composite and a metal material.

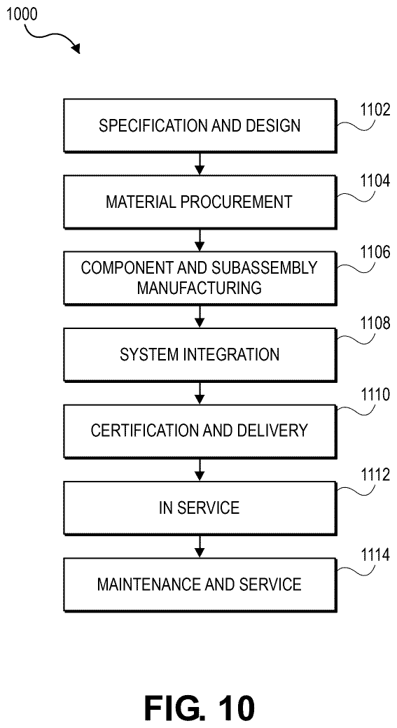

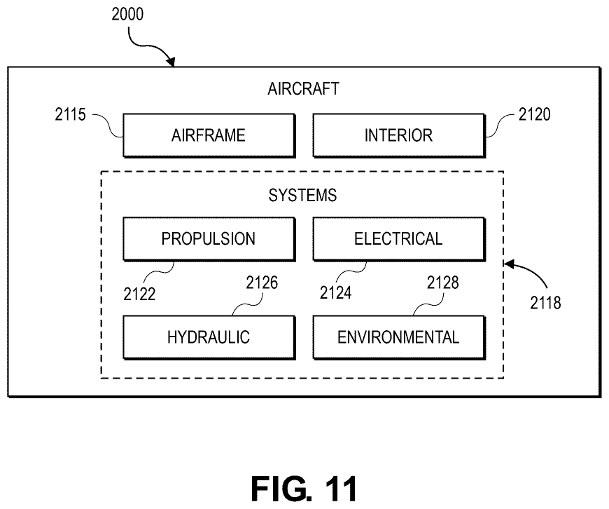

Implementations of the present disclosure may find use in a variety of potential applications, particularly in the transportation industry, including for example, aerospace, marine, rail, automotive applications, and other application where methods for making reinforced sandwich cores and structures are desired. However, the present disclosure is not limited thereto, and implementations of the present disclosure may be used in applications outside the transportation industry. Thus, referring now to FIGS. 10 and 11, implementations of the disclosure may be used in the context of an aircraft manufacturing and service method 1000 as shown in FIG. 10 and an aircraft 2000 as shown in FIG. 11. While FIG. 11 is described in terms of an aircraft 2000, the present disclosure is not limited thereto, and the aircraft manufacturing and service method 1000 can be applied to other structures. During pre-production, aircraft manufacturing and service method 1000 may include specification and design 1102 of the aircraft 2000 and material procurement 1104. During production, component, and subassembly manufacturing 1106 and system integration 1108 of the aircraft 2000 takes place. Thereafter, the aircraft 2000 may go through certification and delivery 1110 in order to be placed in service 1112. While in service by a customer, the aircraft 2000 is scheduled for routine maintenance and service 1114, which may also include modification, reconfiguration, refurbishment, and so on.

Each of the processes of aircraft manufacturing and service method 1000 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 11, the aircraft 2000 produced by aircraft manufacturing and service method 1000 may include an airframe 2115 with a plurality of systems 2118 and an interior 2120. Examples of systems 2118 include one or more of a propulsion system 2122, an electrical system 2124, a hydraulic system 2126, and an environmental system 2128. Any number of other systems may be included. Although an aerospace example is shown, the principles of the disclosure may be applied to other industries, such as the marine and automotive industries.

Systems and methods exemplified herein may be employed during any one or more of the stages of the aircraft manufacturing and service method 1000. For example, components or subassemblies corresponding to component and subassembly manufacturing 1106 may be fabricated or manufactured in a manner similar to components or subassemblies produced while the aircraft 2000 is in service. Also, one or more apparatus examples, method examples, or a combination thereof may be utilized during the component and subassembly manufacturing 1106 and system integration 1108, for example, by substantially expediting assembly of or reducing the cost of an aircraft 2000. Similarly, one or more of apparatus examples, method examples, or a combination thereof may be utilized while the aircraft 2000 is in service, for example and without limitation, to maintenance and service 1114.

While FIGS. 10 and 11 describe the disclosure with respect to aircraft and aircraft manufacturing and servicing, the present disclosure is not limited thereto. The systems and methods of the present disclosure may also be used for spacecraft, satellites, rotorcraft, submarines, surface ships, automobiles, autonomous vehicles, tanks, trucks, power plants, railway cars, and any other suitable type of objects.

The present disclosure has been described with reference to exemplary implementations. Although a few implementations have been shown and described, it will be appreciated by those skilled in the art that changes may be made in these implementations without departing from the principles and spirit of preceding detailed description. It is intended that the present disclosure be construed as including all such modifications and alterations insofar as they come within the scope of the appended claims or the equivalents thereof.

What is claimed, is:

1. A reinforcement film for a sandwich core, comprising:
a removable layer;
a removable adhesive layer;
a reinforcement mesh; and
an adhesive layer,
wherein the removable adhesive layer is disposed on the removable layer and removably joins the removable layer to the reinforcement mesh, and
wherein the adhesive layer is disposed on the reinforcement mesh and the adhesive layer is configured to permanently bond the reinforcement mesh to a sandwich core.

2. The reinforcement film of claim 1, wherein the reinforcement film withstands a temperature of up to and including 350° F.

3. The reinforcement film of claim 1, wherein the reinforcement film is sufficiently flexible to conform to a surface of the sandwich core.

4. The reinforcement film of claim 1, wherein the reinforcement mesh comprises a fiberglass material.

5. The reinforcement film of claim 1, wherein the reinforcement mesh has a thickness from about 1.0 to about 10.0 mil.

6. The reinforcement film of claim 1, wherein the reinforcement mesh defines a plurality of openings with an average diameter from about 0.10 to about 0.50 inch.

7. The reinforcement film of claim 1, wherein the removable layer comprises a non-permeable material that can hold a vacuum.

8. The reinforcement film of claim 1, wherein the removable layer comprises a fiberglass fabric.

9. The reinforcement film of claim 6, wherein the adhesive layer is disposed only on an exterior surface of the reinforcement mesh, such that the adhesive layer does not affect an open mesh nature of the reinforcement mesh.

10. The reinforcement film of claim 9, wherein the adhesive layer does not substantially block or impede the plurality of openings.

11. A method of making a reinforced sandwich core, comprising:
providing a sandwich core;
shaping a first side of the sandwich core;
applying a first reinforcement film to the shaped first side;
shaping a second side of the sandwich core;
applying a second reinforcement film to the shaped second side;
removing a first removable layer from the first reinforcement film and removing a second removable layer from the second reinforcement film; and
cleaning the sandwich core,
wherein the first reinforcement film comprise a first removable layer, a removable adhesive layer, a first reinforcement mesh, and an adhesive layer, wherein said removable adhesive layer is disposed on the first removable layer and removably joins the first removable layer to the first reinforcement mesh, and wherein said adhesive layer is disposed on the first reinforcement mesh, and said adhesive layer is configured to permanently bond the first reinforcement mesh to the first side, and
wherein the second reinforcement film comprise a second removable layer, a removable adhesive layer, a second reinforcement mesh, and an adhesive layer, wherein said removable adhesive layer is disposed on the second removable layer and removably joins the second removable layer to the second reinforcement mesh, and wherein said adhesive layer is disposed on the second reinforcement mesh, and said adhesive layer is configured to permanently bond the second reinforcement mesh to the second side.

12. The method of claim 11, wherein the sandwich core comprises a plurality of hollow cells defining a plurality of air passages between the first side and the second side of the sandwich core.

13. The method of claim 12, wherein the first reinforcement mesh includes a plurality of openings,
wherein applying the first reinforcement film to the shaped first side includes aligning the plurality of openings of the first reinforcement mesh with the plurality of hollow cells in the first side of the sandwich core, and
wherein applying the second reinforcement film to the shaped second side includes aligning the plurality of openings of the second reinforcement mesh with the plurality of hollow cells in the second side of the sandwich core.

14. The method of claim 13, wherein applying the first reinforcement film to the shaped first side comprises at least partially curing the first reinforcement mesh bonded to the shaped first side.

15. The method of claim 13, wherein shaping the second side comprises securing the sandwich core by applying a vacuum to the first reinforcement film.

16. The method of claim 13, wherein removing the first removable layer from the first reinforcement film and removing the second removable layer from the second reinforcement film does not damage the sandwich core.

17. The method of claim 13, wherein cleaning the sandwich core comprises applying a vacuum and/or blowing air through the first reinforcement mesh and the first side and the second reinforcement mesh and the second side to remove debris from the sandwich core.

18. A method of making a reinforced sandwich structure, comprising:
providing a reinforced sandwich core according to claim 11; and
applying a first skin to a first side of the reinforced sandwich core and applying a second skin to a second side of the reinforced sandwich core.

19. The method of claim 18, further comprising curing the first skin and the second skin by applying one of a curing pressure or temperature to the first skin and the second skin disposed on the reinforced sandwich core.

20. A reinforced sandwich structure, comprising:
a sandwich core defining a plurality of hollow cells;
a first reinforcement mesh defining a plurality of openings disposed on a first side of the sandwich core;
a first skin disposed over the first reinforcement mesh;
a second reinforcement mesh defining a plurality of openings disposed on a second side of the sandwich core; and
a second skin disposed over the second reinforcement mesh,
wherein the first and second reinforcement mesh comprise a fiber-reinforced plastic, wherein the plurality of openings in the first reinforcement mesh and the second reinforcement mesh align with the hollow cells, and wherein the plurality of openings in the first reinforcement mesh and the second reinforcement mesh have an average diameter corresponding to at least 20% of an average diameter of the plurality of hollow cells.
